(19) United States
(12) Patent Application Publication
(10) Pub. No.: US 2013/0179341 A1
(43) Pub. Date: Jul. 11, 2013

(54) VIRTUAL WALLET

(71) Applicant: BRUCE BOUDREAU, BURLINGTON (CA)

(72) Inventor: BRUCE BOUDREAU, BURLINGTON (CA)

(21) Appl. No.: 13/736,014

(22) Filed: Jan. 7, 2013

Related U.S. Application Data
(60) Provisional application No. 61/584,095, filed on Jan. 6, 2012.

(51) Int. Cl. G06Q 20/10

(52) U.S. Cl. CPC G06Q 20/105
USPC 705/41; 705/26.8; 705/17

(57) ABSTRACT

The virtual wallet method provides an account routing system that links all end user account issuing institutions to a central portal for electronic commerce transactions. Moreover, the issuing institutions can be linked to the central portal for identification and/or any personal information kept by an institute where an account exists.

### CROSS-REFERENCE TO RELATED APPLICATION

This application claims the benefit of U.S. Provisional Patent Application Ser. No. 61/584,095, filed Jan. 6, 2012.

### BACKGROUND OF THE INVENTION

1. Field of the Invention

The present invention relates to methods for information and financial banking, and particularly to a virtual wallet method that includes methodologies for electronic storage, retrieval, routing and management of personal information, including personal financial information.

2. Description of the Related Art

Most electronic commerce systems and methodologies incorporate a card and means to process payments/withdrawals with the card. These commerce systems typically are customized for one particular institution, merchant, or the like, and thus a user may carry a dozen cards or so to complete a transaction for each institution or merchant.

Electronic wallets focus primarily upon the payment aspects of electronic commerce. For example, electronic wallets comprise credit card account information and digital certificates that are used in authorizing electronic transactions for purchase of a main product sold by a vendor. The functionality of such current electronic wallets is driven by vendor needs, rather than by consumer needs, and does not address the issue of having to carry several cards for access to several merchants/vendors.

Thus, a virtual wallet method solving the aforementioned problems is desired.

### SUMMARY OF THE INVENTION

The virtual wallet method provides methodologies utilizing an account routing system capable of linking all end user account issuing institutions to a central portal for electronic commerce transactions. Moreover, the issuing institutions can be linked to the central portal for identification and/or any personal information kept by an institute where an account exists.

These and other features of the present invention will become readily apparent upon further review of the following specification and drawings.

### BRIEF DESCRIPTION OF THE DRAWINGS

FIG. 1 is a block diagram showing entity relationships in an exemplary implementation of a virtual wallet method according to the present invention.

FIG. 2 is a block diagram showing exemplary institute entities in the implementation of a virtual wallet method shown in FIG. 1.

FIG. 3 is a block diagram showing exemplary portal entities in the implementation of a virtual wallet method shown in FIG. 1.

FIG. 4 is a block diagram showing the exemplary end users in the implementation of a virtual wallet method shown in FIG. 1.

FIG. 5 is a flow diagram showing an exemplary workflow for exemplary functions that may be performed in a virtual wallet method according to the present invention.

FIG. 6 is a block diagram showing an exemplary communication flow that may be utilized in a virtual wallet method according to the present invention.

FIG. 7 is a block diagram showing an exemplary vendor and institute portal configuration that may be utilized by a virtual wallet method according to the present invention.

FIG. 8 is a block diagram illustrating process routing between system components that may be utilized by a virtual wallet method according to the present invention.

FIG. 9 is a front plan view of an exemplary kiosk utilized by a virtual wallet method according to the present invention.

FIG. 10 shows an exemplary web page that may be utilized by a virtual wallet method according to the present invention.

Similar reference characters denote corresponding features consistently throughout the attached drawings.

### DETAILED DESCRIPTION OF THE PREFERRED EMBODIMENTS

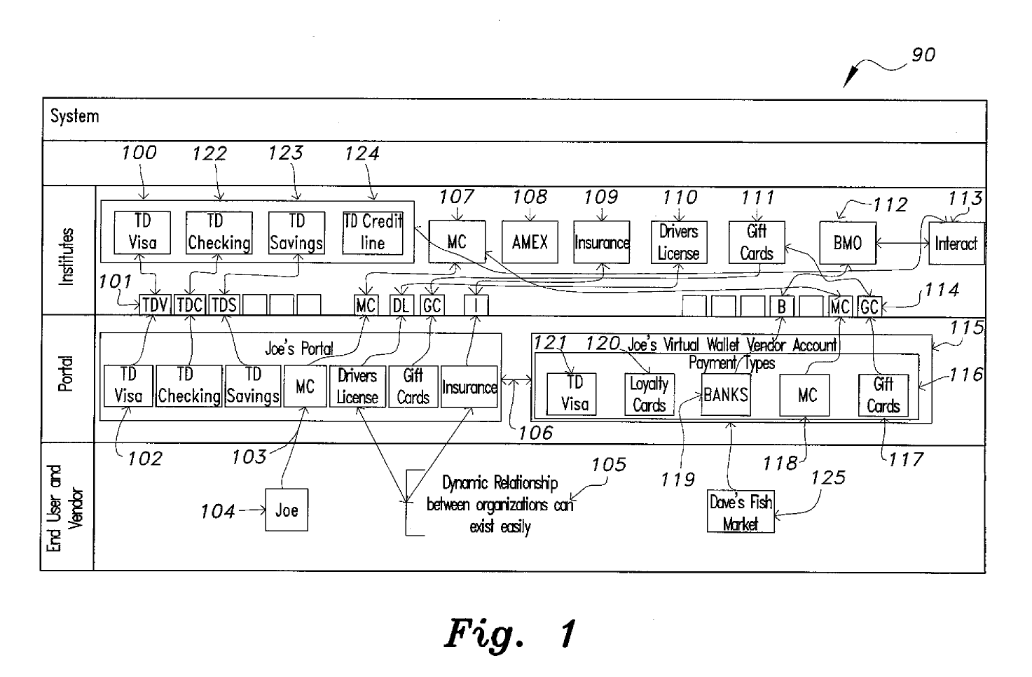

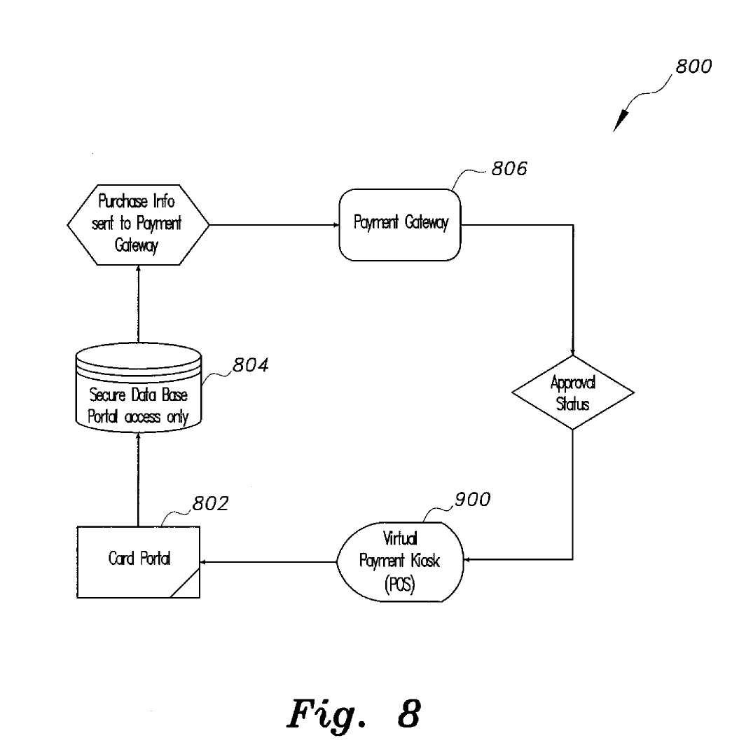

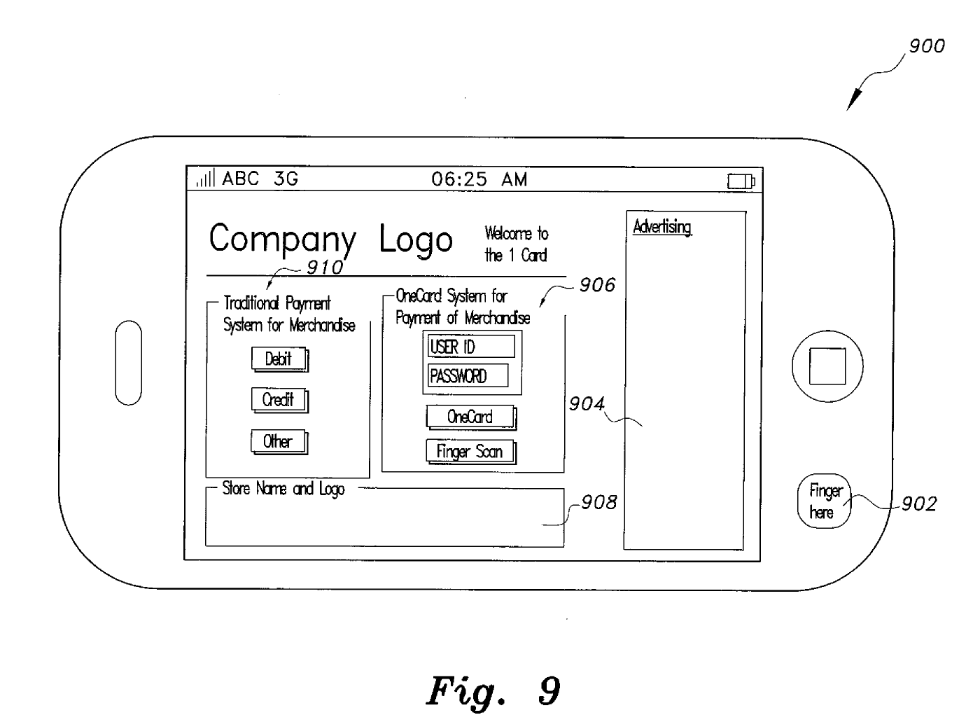

At the outset, it should be understood by one of ordinary skill in the art that embodiments of the present method can comprise software or firmware code executing on a computer, a microcontroller, a microprocessor, or a DSP processor; state machines implemented in application specific or programmable logic; or numerous other forms without departing from the spirit and scope of the method described herein. The present method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions. The present virtual wallet method runs on an account routing system 90 (shown in FIG. 1) that links all end user account issuing institutions to a central portal for electronic commerce transactions. Moreover, the issuing institutions can be linked to the central portal for identification and/or any personal information kept by an institute where an account exists. More specifically, the method combines electronic finance with personal identification into a single graphical user interface (GUI), such as the exemplary kiosk 900 of FIG. 9, a phone, computers, etc., that preferably remotely accesses financial accounts and electronically stored personal information without requiring an access/transaction card or other tangible access article. As shown in FIG. 8, an exemplary process flow includes communication with a kiosk 900 or other communications device in communication with a payment gateway 806 and card portal 802 that communicates with a secure database 804 that sends purchase information to payment gateway 806.

Exemplary identification and access information is electronically and remotely linked by the providing institute, and includes passports, licenses, insurance, as well as financial information, such as credit accounts, bank accounts, and the like.

The method accesses information by utilizing biometric scans, such as fingerprint or retinal scans, which may be performed via the Internet, cellular communication, and the like. The information is accessible through biometric scans, such as fingerprint, retinal scans or saliva DNA detection (this is a device that allows an individual to breath into a sensor, which has the capability of identifying from the breath's humidity the person's DNA) and may be accessed through the Internet, cellular communication etc.

Additional secure PINs and/or passwords or tokens may also be utilized. A new unique random identification method will be utilized to ensure patterns of consumer login are not replicated. The end user account registrant must answer questions that pertain to the registrant's personal information that only registrant knows. This information is then used to randomly ask the registrant to identify the answer when trying to login. For example, when logging in, the registered end user provides user ID, Password, as well as the answer to the proposed randomly provided questions at the time of login. Furthermore, the end user's account setup also requires an emergency code. This code is used to identify to the system that fraudulent behaviour is being conducted. When entering this emergency code, the following will occur.

The end user's portal connection within his/her account will automatically be disconnected to protect him/her. If ever forced to provide personal information, the end user can then provide the emergency code to the perpetrator rather than the real password. Further to using this emergency code, by way of automatic disconnection, all institutes, including police, will be notified of the fraudulent behaviour and its origin.

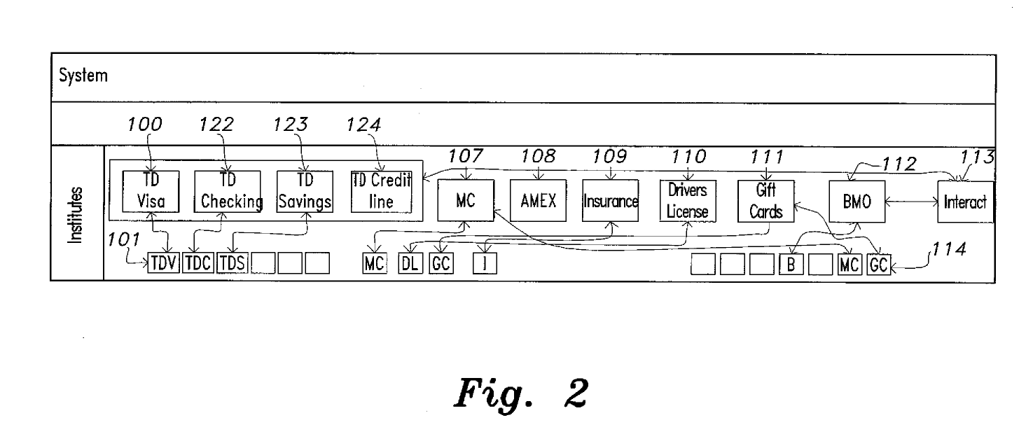

An exemplary structure implementing the method is shown in FIG. 1, and includes an entity structure 90 broadly divided into institutes, portals, vendors and end users. The exemplary system 90 shown includes a VISA® (VISA is a registered trademark of Visa International Service Association) account providing institute 100, checking account providing institute 122, savings providing institute 123, and credit line provider 124. The institutes are most clearly shown in FIG. 2. A secure portal interface 101 routes information from these providers to a mirror portal, e.g., “Joe's Portal”, which has corresponding VISA, checking and savings ports, and the like 102. The portal area of the structure 90 includes a virtual wallet vendor account 115 that exchanges information between the mirror portal 102 and itself via an electronic connection 106. The end user 104 utilizes the communications interoperability between the end user account 103 and the virtual wallet 115 provided by the connection 106.

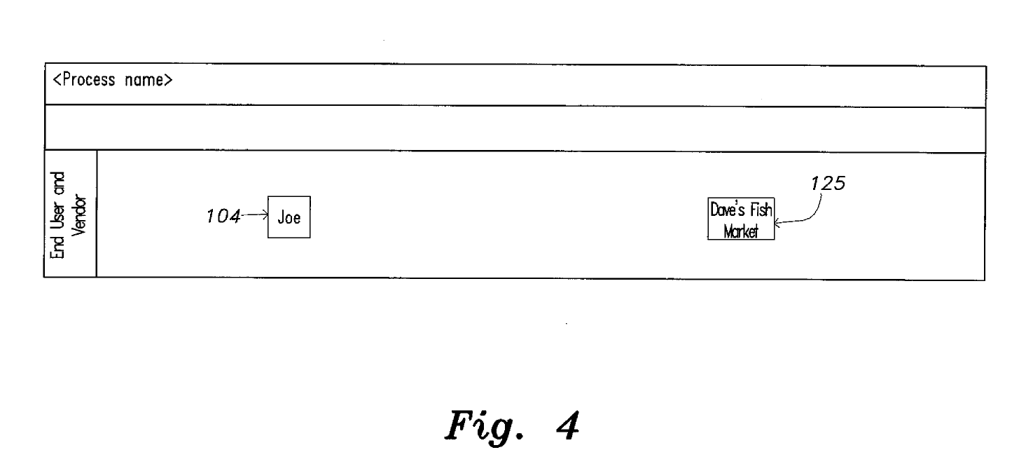

The virtual wallet vendor account 115 has a plurality of payment types 116 which includes a virtual VISA 121, virtual loyalty cards 120, virtual bank cards 119, virtual MasterCard® (MasterCard is a registered trademark of MasterCard International Incorporated) 118 and virtual gift cards 117. The virtual wallet 115 establishes a connection between the user's virtual bank 119 and the exemplary target merchant 125. The end user 104 and the target merchant 125 are most clearly shown in FIG. 4. Moreover, the virtual bank 119 establishes a connection to the actual bank 112 via the bank port B of the vendor portal connector 114. Once these connections are established, the transaction with the merchant 125, i.e., “Dave's Fish Market”, can be completed. Other institutes capable of establishing a connection with the user's virtual wallet 115 include MasterCard institute 107, AMEX (American Express) institute 108, Insurance institute 109 Government agency 110, and Gift Cards institute 111.

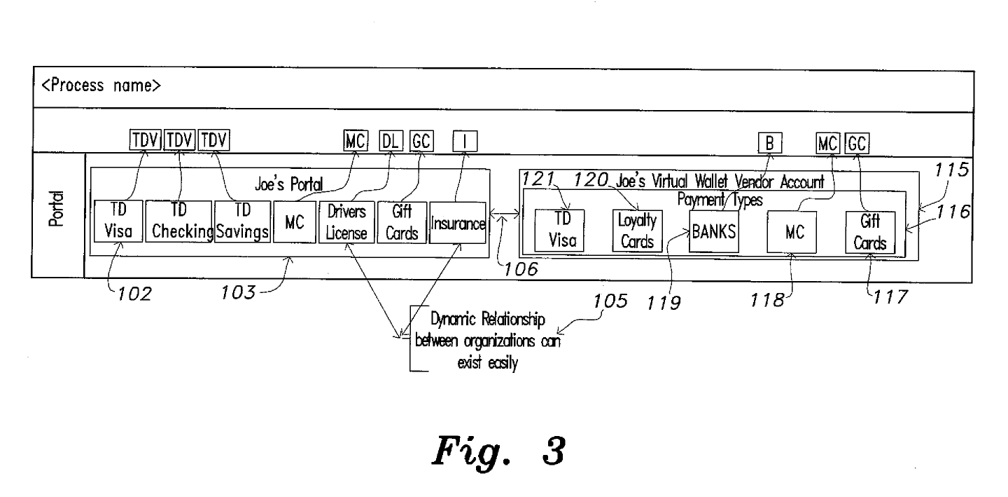

An Institution interaction module 113 allows interactive communication to occur between the aforementioned institutes and another set of institutes, e.g., the “TD” set of institutes 100, 122, 123, and 124 in order to complete a transaction. As most clearly shown in FIGS. 1 and 3, a dynamic relationship 105 between organizations (institutes) is facilitated via interaction module 113.

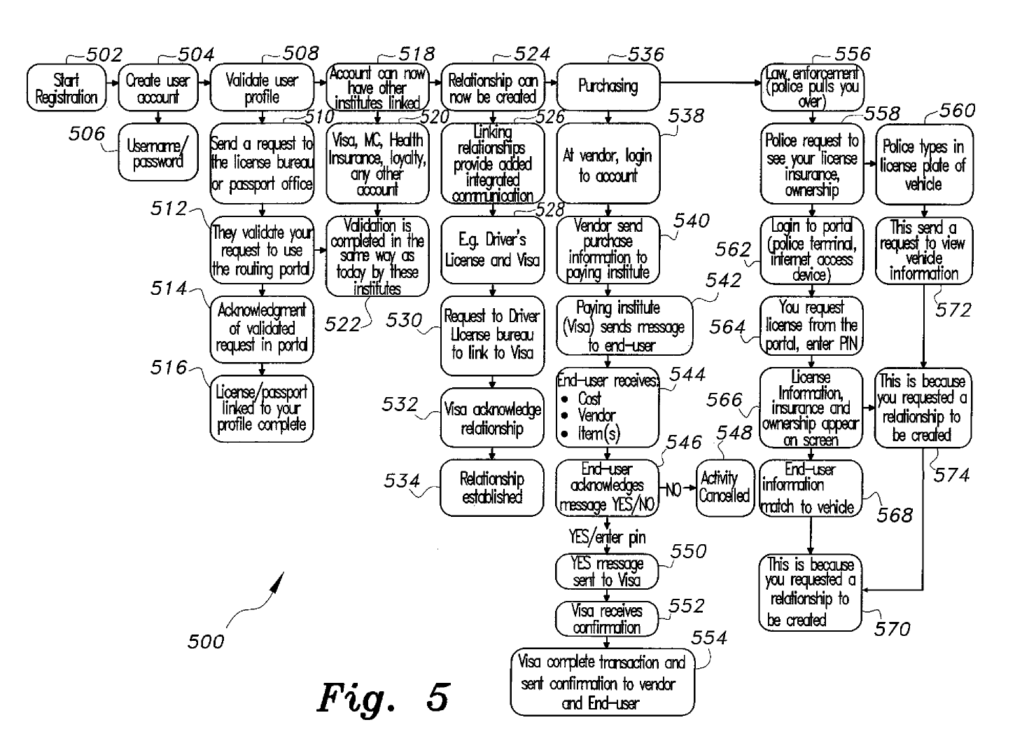

As shown in FIG. 5, the process flow of a registrant through the system 90 includes a registration step 502, account creation step 504, and a username and password assignment 506. The system then performs a user profile validation step 508 and subsequently, at step 510, can send a request to a relevant institute having the user's personal information. At step 512, the relevant institute validates the request to use a routing portal. At step 514, the system acknowledges the validated request in portal. At step 516, the personal information is linked to complete the user's profile. Subsequently, at step 518, the user's account can have additional institutes linked. At step 520, additional institutes are linked. At step 522, validations are completed according to the institutes' existing validation procedures. At step 524, relationships are created. At step 526, linking relationships provide additional integrated communication. At step 528, exemplary institutes are requested to be linked. At step 530, the request is processed. At step 532, the target institute acknowledges the relationship. At step 534, the relationship is established.

With an established relationship, purchasing can then be completed using the virtual wallet method. For example, at step 556, a triggering event can cause an established institutional relationship to allow personal information access between the related institutes, Steps 558 and 560 are an encounter with police. Steps 536, 538, 540, 542, 544, 546, 550, 552, and 554 are a previously user-initiated transaction to pay for auto insurance. An officer via steps 556, 558, 560, 562, 572, 564, 566, 568, 574, and 570 is running the plates for information on the user's vehicle. Since a relationship was previously established with the license bureau at step 510, the officer running the plates has access to verify that the vehicle is insured.

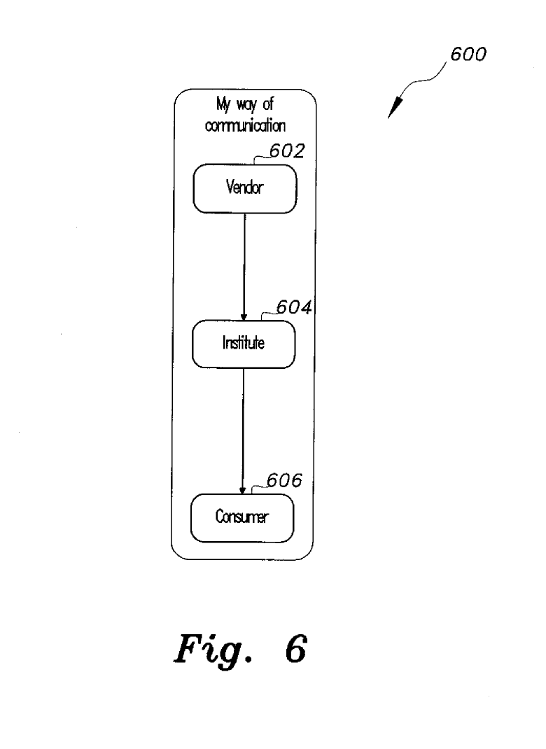

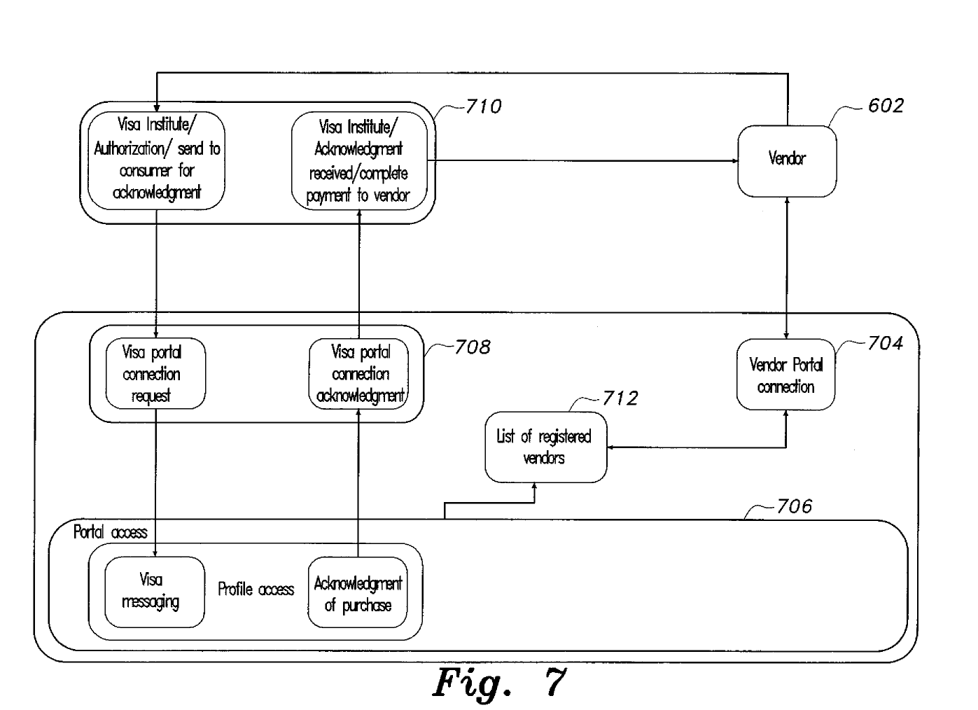

As shown in FIG. 6, the communication methodology 600 comprises a vendor 602, a consumer 606, and an institute 604 being linked to complete a transaction. Referring to FIG. 7, in the exemplary flowchart shown, any type of transaction is handled by the general processes shown. The connection between vendor 602 and institution 710 is a closed loop connection, the institute 710 sending an acknowledgement message to the requesting vendor of a confirmed payment back to the vendor 602. The connection between the vendor 602 and the vendor portal connection 704 is used to connect the vendor to the portal and to register the consumer to the vendor. The connection between an institute and the portal 708 is used to securely connect the institute to a portal/message requesting vendor. The connection between the portal and the portal access area, including account messaging, is used to send the consumer a message that the vendor is requesting payment for a particular transaction. VISA portal connection acknowledgment 708 is sent from the portal access area back to the proposed payor account. Acknowledgment flows back to the institute via a secure connection. A list of registered vendors 712 may be maintained via a vendor portal connection 704. Portal access 706 confirms that a target vendor is on the list 712.

For those who do not wish to use biometrics, an access card including an access ID and the aforementioned PIN numbers and/or passwords may be used. It is also important to note that, functionally speaking, registering an account, such as VISA, in reality is registering a routing accessible to the end user via the providing institute. Once the end-user logs into his or her account, a link to VISA exists, but not the account information. The account information only exists with VISA. It does not need to exist anywhere else. Moreover, the system centralizes user accounts provided by individual institutes routed to a centralized portal, as opposed to centralizing card access.

Furthermore, when transacting a purchase via VISA, a message is sent to indicate that you want to transact using VISA as opposed to sending card/account information for payment. End-users, when accessing their account, are accessing a portal that has links to the varying institutes, and therefore they do not know the card/account information, as it is only held by the providing institute, instead of accessing a central repository that actually contains the card/account information of the end-users.

The consumer's primary business objective is to provide a secure framework where end users have the ability to access their personal information securely and with peace of mind, and where the complexities of technology are made easy. The institute's primary business objective is to provide a method and system whereby account activities are masked virtually to the end-user. Account information is anonymous, untraceable and virtual. It is the institute that holds this information internally. This portal as such, can be described as a form of translator, whereby partnering institutes can form a coalition. For instance, a relationship between the ‘driver's license bureau’ and the ‘insurance company’ of an end user could be established. The relationship could then be leveraged to acquire pertinent information about the end-user without having to track down two separate sources. This can be established with all relevant institutes wanting to provide this feature/ability to their customers.

The method can be globally deployed where appropriate infrastructure is available, and will be used by all end users who transact electronically, whether by Internet, by Kiosk, smart pads, tablets, smart phones, or any electronic device that can connect to the Internet.

Moreover, as part of the technology of the virtual wallet method, the present invention contemplates an application that allows smart devices to transact securely as well, thus obviating the necessity of dedicated store kiosks. Transactions can be completed by way of devices such as smart phones, smart pads, and any other device that can connect to the Internet. By way of being able to transact in this way, the present invention allows individuals to do the following; rather than transacting via the Kiosk, they will simply login to their Portal account (just like swiping at a kiosk) via their smart device application. Using scanning software to incorporate and facilitate the purchase, the end users will select an item in the store, place the camera that is on the smart device in front of the SKU, and scan the item to get the price. As part of the purchase setup, a barcode will exist at the store of purchase. This barcode will be scanned to register the store to an application running on the Portal. The user then scans all of the items he/she wishes to purchase in that store. The cost of the items will aggregate and subtotal as the user shops. Once the user is ready to complete the purchase, the user pays via smart device and confirms the purchase with the attendant at the store (due to electronic confirmation to the vendor) and walk out with the paid for merchandise.

Another exemplary scenario contemplates the use of a weigh-out station during purchase checkout procedure. According to the present invention, as the user shops and walks through the aisles, using a smart device allows the user to scan all products into a buggy (bag hanging setup). Produce gets weighed like the bulk bin items, e.g., where you weigh the items and print their bar code. This allows for ease of scanning and to integrate these items as part of the scanning methodology. If the user does not have a smart device, the store will provide scanning devices that mount on the buggy to allow for scanning during a shopping session. At the end of the shopping session, the user confirms his/her purchases and makes his/her way to a weigh-out station. The weigh-out station is a scale that the cart is pushed on to and allows the entire cart to be weighed.

The Portal application on the user's smart device keeps track of the total purchases so that while the user is shopping the user knows exactly how much he/she is spending. A cashier only confirms the weight registered at the weigh-out station. This is similar to individuals scanning their products at self-checkout stations today. The difference is that they do not need to remove all items from their basket and or buggy because the user scanned and paid for all items during the shopping session. At the weigh-out station the inventive system confirms and validates that what was paid for matches the weight and the list of items confirmed to the cashier at the weigh-out station via a confirmation number. The weigh-out station weighs the entire basket/buggy at one time. Once confirmed/validated the user walks out.

In summary of the aforementioned smart device transaction procedure, the present method allows the user to scan a store barcode at a storefront, and then start scanning items, wherein checkout sends scanned information to cashier. The present method allows the cashier to validate purchases and print off the user's bill in the form of a barcode. Using the user's smart phone (or any other device that is connected to the internet) the user then scans the barcode which reveals the total amount owed. The user then accepts the amount and continues to the system's website to make the payment via the portal routing method. Subsequently according to the inventive method an e-mail receipt is sent to the user after completion of the purchase transaction.

Ultimately, the method's configuration will allow end users to access multiple types of accounts that are registered to their name today simply by way of logging into their secure portal.

Furthermore, to the concepts explained thus far, there are many other added benefits that can be leveraged. Conceptually, what this process does is link the virtual world to the tactical. The link is seamless to the end users, as they are connected to the Internet and transacting without the use of their own personal computer. From an Internet perspective, the method links the non-computer market to the cyberworld.

The method provides a secure and easy method for people to view their personal information electronically using existing technologies, mainly through a Web interface. Also, the method makes easy the process where individuals either require the ability to purchase, or to render proof of ID, such as passports, licenses, health cards, social insurance numbers etc. In fact, ultimately, the method makes all end-user accounts that exist in their life today accessible virtually in a secure location. The method enables one to access and supply all and any personal information, the information being directly supplied by the respective companies or government agencies, to anyone globally with the ease of using an Internet portal. As with other Internet sites, access to the portal would be granted via a username and password. The use of biometrics, token keys and other means, including access cards, to elevate secure login to access the account can be incorporated as well.

The use of a card is the customer's choice. Note that a pin/password and a token random pin generator would be required. However, by itself the card is valueless. Furthermore, accessing this account is done using existing technologies, which include the Internet, Internet providers, networks (including 3G and 4G), and any other new technology that could provide the same type of access to a website, application or GUI, and the like. Also, the way in which the ‘Portal’ works is by using the existing communication media that institutes use today. As an example, VISA uses Cirrus, and therefore when transacting to complete a purchase, at the time the end user selects VISA, whatever network VISA communicates on or means in which it completes the transaction will continue to be utilized. The virtual wallet method portal eliminates the necessity of using an access card to transact business with merchants and the like. When a card expires or requires renewing, what is really occurring is the renewing of the end user account with that institute. This can now be facilitated by means of internal messaging via the portal and/or via email and or the portal access to communicate account update information.

Internal messaging system and/or e-mail works in such a way that when the end-users register with the website, the method requires them to include all of their personal information to identify who they are. Included in this setup is their internal message system, as well as e-mail addresses. Whenever an end-user requests that one of their accounts be linked to the portal for ease of access and usability, the providing institute would send them a confirmation of the completed setup via e-mail.

When the end-users register with the web site, the end user includes all personal information requested by the method to authenticate the identity of the end user. After receiving notification that the providing institute has completed their part by linking 101, acknowledgement of its setup is required by the end-user 104.

The method is implemented by interactive components that drive the complete system. A secure web site is provided to host the ‘portal connectivity’. A GUI interface provides secure connection to the web site. An account is provided to register your portal links. Moreover, at the vendor is a “virtual payment kiosk”. A secure database that is accessed only by the portal is also provided.

An exemplary kiosk 900 is shown in FIG. 9, and includes a biometric input 902, an advertising screen area 904, a store name and logo area 908, a virtual wallet method payment interface 906, and a traditional method payment interface 910.

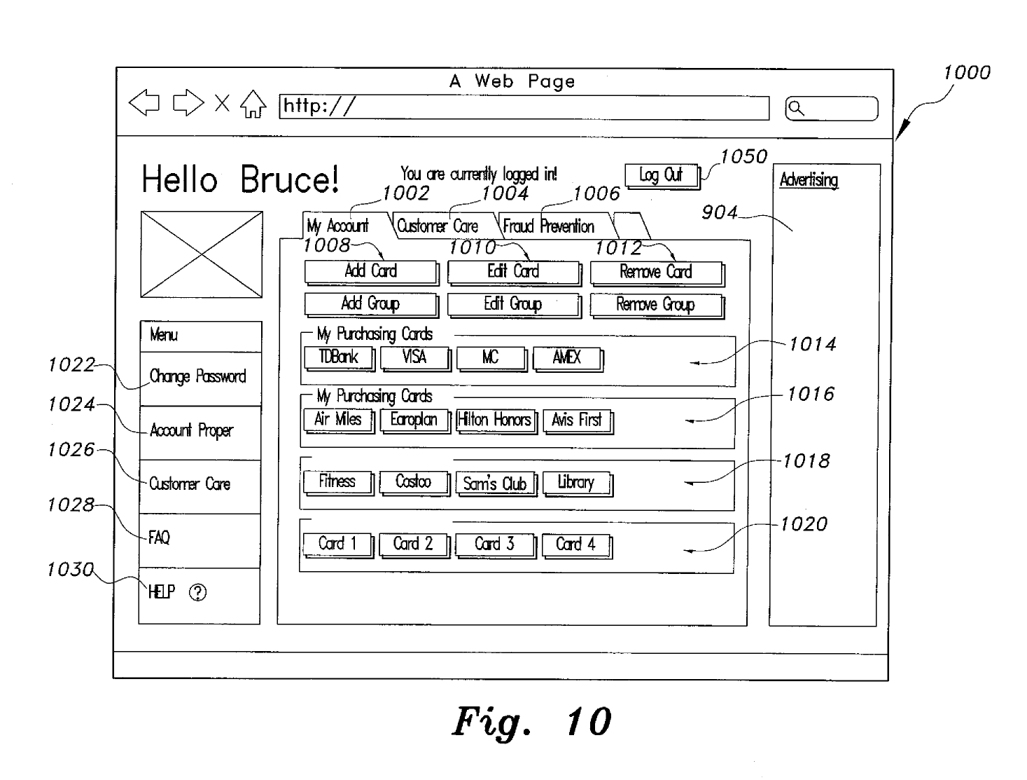

The portal website 1000 (shown in FIG. 10) is the command central of the method. It will allow individuals to create an account with their own personal username and pin/password, which will provide them access to their account and use of the site functions. Once an account is created, the only way to access the account is by way of their user name and pin/password. There is no sharing, linking, connecting etc., between end user accounts. There would be no point in providing this type of linking, as the access being acquired is simply a toggle switch that routes the request to the varying institutes in which the account is actually registered and housed. The exemplary web page 1000 includes an account tab 1002, a customer care tab 1004, and a fraud prevention tab 1006. Add card and group touchscreen buttons 1008, edit card and group touchscreen buttons 1010, and remove card and group touchscreen buttons 1012 are provided. Purchasing cards touchscreen buttons 1014 are provided. Loyalty cards touchscreen buttons 1016 are provided. Membership cards touchscreen buttons 1018 are provided. Additionally, gift cards touchscreen buttons 1020 are provided. User log out touchscreen button 1050 is provided near the top of the web page 1000. A menu on the left side of the web page 1000 includes a password management button 1022, an account properties button 1024, a customer care button 1026, a FAQ button 1028, and a help button 1030. Preferably these buttons are touchscreen type buttons.

The linked accounts to be routed, if agreement with providing vendors has been reached, can be setup to automatically save a password when a request to transact is initiated. Otherwise, one can opt to not set it up with a password, and to enter one's password/PIN at the time of use. Meaning, if a user deals with TD Canada Trust, and sets up an account under a user's profile and selects save password, this means that when the user requests use of this account, the user will only have to enter the user's TD specific user ID and password to complete the request. If the user did not set it up to save the password, the user would have to enter the portal user ID and password, and when choosing DT Canada Trust, the user would also have to enter the coinciding pin/password. GUI Portal access can be accomplished via the Internet web site, as well as through the use of an application, which can be installed on any device that connects to the Internet.

The method includes allowance for a portal access card, which is the tool that allows the user to swipe at a Kiosk securely to gain access to the user's portal. The portal access card functions as a mechanism to bring up the user's user name that was created when the user originally setup the user's account. The card has no intrinsic value, as it simply holds the user's name information. Therefore, all users' cards can stay at home. However, when choosing to use a card for access, if lost or stolen, simply replace and re-register via the Web, the bank, or by phone via customer-care agents. Thus, users never have to cancel their cards or associating account. The card is optional, meaning, it is there to provide login convenience at the time of wanting to access account information. If a user has lost or forgotten a card, the user simply provides the user name manually by entering it on the screen.

The Database will be used to house individual card information. The database is only accessible by the portal, and the portal can only communicate this information to the payment gateway. No personal information is transferred to the vendor. Only the result of the payment approval is messaged to the vendor/institute.

The Virtual Payment Kiosk is a device that exists at the location needing a Point of Sale terminal (POS). This Kiosk will differ from others that exist today in that it will have the ability to transact existing cards in the way we do today, but, in addition, will also be able to access the Card Portal. Having the ability to access the card portal enables the user to pay for an item without having to carry ID or purchase cards with us.

It is to be understood that the present invention is not limited to the embodiments described above, but encompasses any and all embodiments within the scope of the following claims.

I claim:

1. A computer-implemented virtual wallet method, comprising the steps of:
establishing a central portal web site connected to a network;
registering a plurality of end users with the web site, including issuing a unique username and password for accessing the central portal web site to each of the end users;
receiving a request from the end users to include accounts with financial institutions in the end users' corresponding virtual wallet;
establishing a link to the financial institutions requested by the end users;
receiving a request from the end users to include accounts with institutions maintaining non-financial personal information regarding the end users in the end users' corresponding virtual wallet;
establishing a link to the institutions maintaining non-financial personal information requested by the end users;
upon authenticating one of the end user's username and password, connecting the end user to the financial institution through the link to access the end user's financial information stored by the financial institution; and
upon authenticating one of the end user's username and password, connecting the end user to the institution maintaining the end user's non-financial personal information through the link to access the end user's non-financial personal information stored by the institution.

2. The computer-implemented virtual wallet method as claimed in claim 1, further comprising the step of combining electronic finance with personal identification into a single graphical user interface that preferably remotely accesses financial accounts and electronically stored personal information without requiring an access/transaction card or other tangible access article.

3. The computer-implemented virtual wallet method as claimed in claim 2, further comprising the step of providing access to said account information only upon successful verification via biometric scan.

4. The computer-implemented virtual wallet method as claimed in claim 3, further comprising the step of providing an emergency code in an end user's account, the emergency code being used to identify to the system that fraudulent behaviour is being conducted.

5. The computer-implemented virtual wallet method as claimed in claim 4, further comprising the steps of:
automatically disconnecting said end user's account upon system receipt of said emergency code; and
automatically notifying all institutes, including police of said fraudulent behaviour and its origin.

6. The computer-implemented virtual wallet method as claimed in claim 4, further comprising the steps of:
using scanning software to incorporate and facilitate the purchase of goods and services;
accepting a product SKU code photographed from a mobile smart device;
displaying on said mobile smart device a price of said product represented by said SKU code;
scanning a barcode at a store of said purchase, said barcode scan registering said store to an application running on said portal;
said portal application accepting price scans of all items said user wishes to purchase in said store;
accepting user payment via said smart device; and
confirming said purchase with an attendant at said store.

7. The computer-implemented virtual wallet method as claimed in claim 6, wherein said smart device is a shopping cart having a weigh station for weighing and pricing produce.

8. The computer-implemented virtual wallet method as claimed in claim 7, further comprising the step of verifying weight of purchased goods via a weigh-out station scale, thereby allowing said entire shopping cart to be weighted.

9. The computer-implemented virtual wallet method as claimed in claim 6, further comprising the step of accessing a card portion of said portal responsive to user input from a Kiosk at a point of sale (POS), said card portal access allowing said user to pay for an item without having to carry a physical card and physical identification.

10. A computer software product, comprising a non-transitory medium readable by a processor, the medium having stored thereon a set of instructions for performing a virtual wallet method, the set of instructions including:
(a) a first sequence of instructions which, when executed by the processor, causes said processor to establish a central portal web site connected to a network;
(b) a second sequence of instructions which, when executed by the processor, causes said processor to register a plurality of end users with the web site, including issuing a unique username and password for accessing the central portal web site to each of the end users;
(c) a third sequence of instructions which, when executed by the processor, causes said processor to receive a request from the end users to include accounts with financial institutions in the end users' corresponding virtual wallet;
(d) a fourth sequence of instructions which, when executed by the processor, causes said processor to establish a link to the financial institutions requested by the end users;
(e) a fifth sequence of instructions which, when executed by the processor, causes said processor to receive a request from the end users to include accounts with institutions maintaining non-financial personal information regarding the end users in the end users' corresponding virtual wallet;
(f) a sixth sequence of instructions which, when executed by the processor, causes said processor to establish a link to the institutions maintaining non-financial personal information requested by the end users;
(g) a seventh sequence of instructions which, when executed by the processor, causes said processor to upon authenticating one of the end user's username and password, connect the end user to the financial institution through the link to access the end user's financial information stored by the financial institution; and
(h) an eighth sequence of instructions which, when executed by the processor, causes said processor to upon authenticating one of the end user's username and password, connect the end user to the institution maintaining the end user's non-financial personal information through the link to access the end user's non-financial personal information stored by the institution.

11. The computer software product as claimed in claim 10, further comprising a ninth sequence of instructions which, when executed by the processor, causes said processor to combining electronic finance with personal identification into a single graphical user interface that preferably remotely accesses financial accounts and electronically stored personal information without requiring an access/transaction card or other tangible access article.

12. The computer software product as claimed in claim 11, further comprising a tenth sequence of instructions which, when executed by the processor, causes said processor to provide access to said account information only upon successful verification via biometric scan.

13. The computer software product as claimed in claim 12, further comprising an eleventh sequence of instructions which, when executed by the processor, causes said processor to provide an emergency code in and end user's account step, the emergency code being used to identify to the system that fraudulent behaviour is being conducted.

14. The computer software product as claimed in claim 13, further comprising:
a twelfth sequence of instructions which, when executed by the processor, causes said processor to automatically disconnect said end user's account upon system receipt of said emergency code; and
a thirteenth sequence of instructions which, when executed by the processor, causes said processor to automatically notify all institutes, including police of said fraudulent behaviour and its origin.

15. The computer software product as claimed in claim 13, further comprising:
a fourteenth sequence of instructions which, when executed by the processor, causes said processor to use scanning software to incorporate and facilitate the purchase of goods and services;
a fifteenth sequence of instructions which, when executed by the processor, causes said processor to accept a product SKU code photographed from a mobile smart device;
a sixteenth sequence of instructions which, when executed by the processor, causes said processor to display on said mobile smart device a price of said product represented by said SKU code;
a seventeenth sequence of instructions which, when executed by the processor, causes said processor to scan a barcode at a store of said purchase, said barcode scan registering said store to an application running on said portal;
an eighteenth sequence of instructions which, when executed by the processor, causes said processor to accept price scans of all items said user wishes to purchase in said store;
a nineteenth sequence of instructions which, when executed by the processor, causes said processor to accept user payment via said smart device; and
a twentieth sequence of instructions which, when executed by the processor, causes said processor to confirm said purchase with an attendant at said store.

16. The computer software product as claimed in claim 15, further comprising a twenty-first sequence of instructions which, when executed by the processor, causes said processor to weigh and price produce in a smart device configured as a shopping cart having a weigh station.

17. The computer software product as claimed in claim 16, further comprising a twenty-second sequence of instructions which, when executed by the processor, causes said processor to verify weight of purchased goods via a weigh-out station scale, thereby allowing said entire shopping cart to be weighted.

18. The computer software product as claimed in claim 15, further comprising a twenty-third sequence of instructions which, when executed by the processor, causes said processor to access a card portion of said portal responsive to user input from a Kiosk at a point of sale (POS), said card portal access allowing said user to pay for an item without having to carry a physical card and physical identification.
